(19) United States
(12) Patent Application Publication
(10) Pub. No.: US 2015/0099481 A1
(43) Pub. Date: Apr. 9, 2015

(54) METHOD AND SYSTEM FOR PROVIDING ALERT NOTIFICATIONS

(71) Applicant: White Cheetah, Inc., Fort Collins, CO (US)

(72) Inventors: Heather Maitre, Fort Collins, CO (US); Andrew Claiborne, Fort Collins, CO (US); J. Christopher Connelly, Fort Collins, CO (US); Patrick Johnson, Fort Collins, CO (US); Sharon Matthews, Fort Collins, CO (US); Mark Nery, Fort Collins, CO (US); Richard Von Feldt, Fort Collins, CO (US); Victoria Winters, Fort Collins, CO (US); Karie Willyerd, Fort Collins, CO (US)

(21) Appl. No.: 14/506,581

(22) Filed: Oct. 3, 2014

Related U.S. Application Data
(60) Provisional application No. 61/886,532, filed on Oct. 3, 2013.

(51) Int. Cl. H04W 4/22; H04L 29/08

(52) U.S. Cl. CPC H04W 4/22; H04L 67/12; H04L 67/18
USPC 455/404.2

(57) ABSTRACT

Disclosed herein is a method and system for providing various alert notifications to individuals. More specifically, the embodiments disclosed herein are directed to obtaining an alert notification from an external source and determining a geographic area associated with the alert notification. Once the geographic area has been determined the methods and systems described determine one or more users in the geographic area that meet one or more alert criteria. An alert notification is then generated and is provided to one or more users in geographic areas that meet the one or more alert criteria.

### CROSS-REFERENCE TO RELATED APPLICATIONS

The present application claims priority to U.S. Provisional Patent Application No. 61/886,532 entitled Mobile Social Safety and Alerting Application, filed on Oct. 3, 2013. The aforementioned application being incorporated by reference in its entirety.

### TECHNICAL FIELD

The present disclosure is directed to a system that enables various individuals to learn about and provide emergency as well as non-urgent data and related notifications to other individuals. More specifically, embodiments of the present disclosure are directed to a social safety platform that obtains emergency as well as non-urgent data from various sources including authoritative data feeds, social networking sites and various users and automates the aggregation, determination and dissemination of this data based on various criteria.

### BACKGROUND

Many mobile devices have access to the internet and enable various users to obtain information about news, current events, natural disasters and so on. However, in order to obtain this information, an individual may be required to subscribe to a number of different news feeds and other organizations. Further, when a natural disaster or other such event occurs, each news feed may provide information about the event to the individual. As a result, the individual may obtain multiple notifications about the same event, and these notifications are generally not geographically or contextually specific to the user.

It is with respect to these and other general considerations that embodiments have been made. Although relatively specific problems have been discussed, it should be understood that the embodiments should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Embodiments disclosed herein are directed to providing alert notifications to various individuals. More specifically, the embodiments disclosed herein are directed to obtaining an event notification from an external source and determining a geographic area associated with the event notification. Once the geographic area has been determined the methods and systems described are used to determine one or more users in the geographic area that meet one or more alert criteria. An alert notification is then generated and is provided to one or more users in the geographic area that meet the one or more alert criteria.

### BRIEF DESCRIPTION OF THE DRAWINGS

Embodiments of the present disclosure may be more readily described by reference to the accompanying drawings in which like numbers refer to like items and in which:

FIG. 1 illustrates an exemplary system for generating and providing alert notifications according to one or more embodiments of the present disclosure;

FIG. 2 illustrates a method for generating alert notifications based on information obtained from various sources according to one or more embodiments of the present disclosure;

FIG. 3 illustrates a method for providing additional information about an alert notification according to one or more embodiments of the present disclosure;

FIG. 4 illustrates an exemplary user interface that may be used to show various alert notifications according to one or more embodiments of the present disclosure;

FIG. 5 illustrates an exemplary user interface that may be used by an administrator or other user to provide information about various individuals associated with an alert notification according to one or more embodiments of the present disclosure;

FIG. 6A-FIG. 6B illustrates additional exemplary user interfaces that may be used to provide information about an alert notification according to one or more embodiments of the present disclosure;

FIG. 7A-FIG. 7B illustrates another exemplary user interface that may be used to provide information about one or more alert events according to one or more embodiments of the present disclosure; and

FIG. 8 is a block diagram illustrating example physical components of a computing device that may be used with one or more embodiments of the present disclosure.

### DETAILED DESCRIPTION

Various embodiments are described more fully below with reference to the accompanying drawings, which form a part hereof, and which show specific embodiments for practicing the embodiments described herein. However, various embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects.

The present disclosure is directed to a system that is configured to obtain various event notifications from various private and public entities, via a multitude of data and information paths. The event notifications are then aggregated or otherwise combined and provided to various users and individuals based on, for example, various criteria. For example, the system described herein may obtain event notifications from government entities, social media, individual users and so on.

For example, weather information (e.g., severe weather information) may be obtained from a national weather service and additional information may be provided by crowd-sourced data or social media. Likewise, terrorism information may be obtained from a national alerting system (such as the DHS NTAS) and additional information may be provided by crowd-sourced data or social media. The information may be obtained by the system in the form of messages (e.g., text, voice and so on), video and pictures. Further, this information may be associated with a geographical area, with organizational information, time, and so on.

Although embodiments described herein are directed to actively acquire (or obtain) the data from the one or more sources, it is contemplated that the embodiments described herein may be used to receive data from the various sources. For example, the system described herein may be set up to passively receive data and/or actively request the data from the one or more sources.

In some embodiments, alerts of various types can be aggregated, and any element of the alert stack can be layered to provide a customized map display, generating real-time situational intelligence at a macro or granular level. Thus, the information displayed in the map may be useful in preventing and mitigating damage from various types of disasters, emergencies, and other unusual situations, including floods, fires, storms, civil disturbances, and terrorist activity, to name but a few applications.

More specifically, as this information is obtained by the system, the information is stored in remote storage devices, some of which are geographically dispersed to enhance disaster recovery, and which are configured to accommodate load balancing within the system. The obtained information may also be tagged, aggregated, filtered or otherwise processed to determine the type of emergency or other event, the urgency of the emergency or other event, who is affected, who should be notified, what areas are affected and so on. The information may also be processed using various algorithms that: 1) filter irrelevant “noise” which does not provide usable and/or relevant situational intelligence, 2) extracts situation descriptors, 3) determines the relevant geographic area, and 4) identifies users in that particular area. For example, the software monitors its own user messages, social media and mainstream media sources for alert content, and creates relevant alerts based on an intelligent algorithm.

In another example, the system may be configured to filter the obtained data and subsequently provide tailored and variably escalated alert notifications to various individuals based on the proximity of the individual to the danger, as well as on the type of situation or on the nature of the threat. For example, one individual might need to be alerted thirty minutes before projected impact of a tornado, while another individual might need to be alerted within ten minutes of projected impact of a tornado. In other implementations, the system maintains the status of all users or individuals that an organization has stewardship over various individuals along with the individual's proximity to the affected area. In some embodiments, the status of the individuals that are outside an organization's stewardship can be viewed (as anonymous individuals) on a map or other user interface.

As such and as will be described below, the embodiments disclosed herein are directed to aggregating large data sets and layering and/or filtering the data using several inputs. The data may be filtered on work and personal circles, public and private alert data, crowd-sourced intelligence and organizationally defined hierarchies, geographic areas of interest, time, and the like. The system may process the visual interface dynamically, in real time, either in a list format, a map format or other type of user interface. For example, a visual priority overlay may be generated based on selected filters. In addition, government, third party and private alerts may also be output on the map to provide detailed situational intelligence about a threat situation.

The system is also configured to determine safety and status of various individuals or groups of individuals who are part of social and work circles as well as the status and safety of second tier or second degree connections in relation to a disaster, event or threat situation. The system also provides or otherwise enables the viewing of consolidated, filtered intelligence on a map in real-time as data is automatically filtered based on an individual's location and social circles.

The system also enables individuals to filter data based on type, severity, or alert source (e.g., earthquake, severe weather, the social circle from which the data came, organizationally-issued alert, and so on). In yet other embodiments, the system enables users to view organizationally-specific locations on a map and their proximity to the user's current location, as well as other locations of interest to the organization, the location of individuals within his or her circle and to alerts that have been issued.

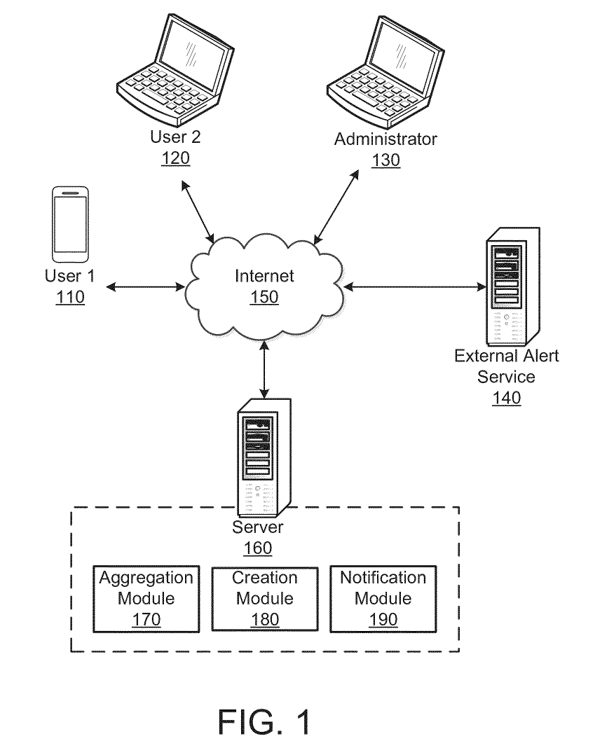

FIG. 1 illustrates an exemplary system 100 for generating and providing alert notifications according to one or more embodiments of the present disclosure. In some embodiments, the system 100 may be configured to obtain various event notifications from a variety of sources, parse, aggregate and otherwise combine information about the various event notifications, generate alert notifications that are based on the obtained event notifications and enable the dissemination of information associated with each event/alert notification. These event notifications and their associated alert notifications may include information about natural disasters, severe weather conditions, terrorist activities, threat situations and other emergency events or conditions as well as other matters related to the safety and security of various individuals.

In some embodiments, the system 100 may be used by various organizations to assist in monitoring the safety and wellbeing of individuals the organization has stewardship over. For example, if the organization is a school district, the system 100 may track the location and responsiveness of students and teachers in the school district when emergencies arise. Likewise, teachers, school administrators, parents and/or family members may use the system 100 to access and/or provide updates on the location, health, and safety of each student. Additionally, the system 100 may be used to obtain and/or provide instructions to the various individuals.

For example, if a tornado hit or was expected to hit near a school, a hospital or other facility, the organization in charge of that facility could access the system 100 to warn its employees of the pending tornado. In cases where the disaster already occurred, the organization could utilize the system 100 to determine a status of the facility, determine a location of various individuals, provide instructions to first responders and injured individuals, as well as providing status and other information to other family members.

As shown in FIG. 1, the system 100 may enable various individuals to access the system 100 using various computing devices. These devices may include cell phones, smart phones, tablet computers, laptop computers, desktop computers, wearable electronic devices (e.g., digital glasses) and so on. For example, as shown in FIG. 1, User 1 110 may access the system 100 using a mobile device that is connected to the internet 150. In some embodiments, the location of User 1 110, as well as other users of the system 100, may be provided to the system 100 at periodic intervals. These updates may be provided automatically, requested by the system 100 or a combination thereof.

Likewise, User 2 120 and administrator 130 may also access the system 100 using various other computing devices. For example, each user of the system may provide messages and information to the system 100 over various network topologies. Likewise, each user of the system 100 may obtain information and messages from the system 100 over the internet 150 or other network topologies.

Although specific users are shown, the system 100 may be accessible to various users and individuals. In some embodiments, User 1 110, User 2 120 and administrator 130 may be part of the same organization. In other embodiments, User 1 110 and administrator 130 may be part of the same organization while User 2 120 is not a part of the organization. However, in some embodiments, User 2 120 may be provided access to the system 100 due to a relationship with the organization or with an individual in the organization. In yet other embodiments, User 2 120 may have access to the system 100 as a result of a subscription or other access policy.

As discussed above, the system 100 may be provided by a particular organization. In some embodiments, administrator 130 may be associated with the organization and grant permissions to various users. As will be described below, these various permissions may include enabling users to access the system 100 including enabling users to generate and/or post alerts and other warnings.

The system 100 also includes a server 160, or combinations of servers and other computing devices. The server 160 is configured to obtain various event notifications from each user of the system 100. For example, User 1 110 may be a witness to a particular disaster or other emergency situation. As such, User 1 110 (depending on permissions granted from the administrator 130) may create a message on a computing device and provide details about the event to the server 160. In some embodiments, the information about the event may be entered in an application that is executing on the mobile device. In another embodiment, the details about the event may be photographed, video recorded, entered as a text or voice message and so on and provided to the server 160.

In some embodiments, the user may select an organizational context for the message. The organizational context may be selected from a list of choices displayed in a user interface. In some embodiments the user may set the location in which the event is occurring. In other embodiments, the message itself, whether obtained from a user or the External Alert Service 140 may contain the location of the event.

In addition to the information discussed above, the event notifications obtained by the server 160 may include the location of the individual sending the message, the location of the event, an identifier of the user or the feed from which the event information is obtained and various other identifying characteristics about the event.

In another embodiment, the server 160 may be configured to obtain alert notifications and other status information from an External Alert Service 140. Although a single alert service is shown, it is contemplated that the alert notifications may come from a variety of sources including private and public sources. These services include, but are not limited to, social media, RSS feeds, data scraping, news organizations, the National Oceanic and Atmospheric Administration (NOAA), the Federal Emergency Management Agency (FEMA), the Federal Communications Commission (FCC) the Department of Homeland Security, the National Weather Service and so on.

The server 160 may be configured to periodically request updates from the External Alert Service 140 at various times. In some embodiments, the request may occur at set time intervals. In another embodiment, the requests may occur at variable times based on the event notifications obtained. For example, if an event notification associated with a tornado warning is obtained and identified by the server 160, the server 160 may request that updates occur more frequently when compared to when a tornado warning is not present.

As the server 160 obtains the various feeds, either from individual users and/or from the External Alert Service 140, the server 160 is configured to aggregate the obtained information, filter or otherwise process the information, generate alert notifications and provide the alert notifications to various users of the system 100. Accordingly, the server 160 may have various modules and components including an aggregation module 170, a creation module 180 and a notification module 190.

In some embodiments, the aggregation module 170 is configured to determine the location and/or area associated with each obtained event notification based on information contained in the event notification. The information may include locations from GPS and other satellite technology, longitude and latitude coordinates, state, county, city, street or area names and so on. The aggregation module 170 may also be configured to determine the severity of the event based on information contained in each event notification.

For example, each obtained event notification may provide information regarding a particular natural disaster, severe weather, terrorist attack and/or other such matters of personal safety and concern. Once all this information is obtained, the aggregation module 170 stores the event information in a database or other storage device.

In some embodiments, the aggregation module is configured to take the information from the various feeds and automatically parse and organize the data. This may include checking a timestamp associated with each obtained event notification, identifying the individual or organization that sent the event notification and/or the reliability of the information contained in the event notification. For example, in some embodiments, event notifications obtained from a first responder may be deemed more relevant than event notifications obtained from various other users.

The server 160 also includes a creation module 180. In some embodiments, the creation module 180 obtains the aggregated information from the aggregation module 170 and generates one or more alert notifications that are associated with the obtained event notifications. In some embodiments, the creation module 180 may generate alert events or other messages that are tailored for specific individuals or groups of people. For example, the creation module 180 may be configured to generate a first alert notification for a first group of people and a second alert notification for a second group of people. In a more specific example, the first alert notification may be generated for first responders while a second alert notification may be generated from individuals that are within a certain distance from the emergency.

The generated alert notification may include an expiration period (e.g., a time in which the alert notification is no longer deemed relevant), geographical information, severity of the emergency, number of people injured, missing, etc., resources available, locations of first responders including the number of first responders at the site, first responders traveling to and from the site and so on.

Once the alert notifications have been generated, the notification module 190 may be configured to provide the alert notifications to various individuals. In some embodiments, the administrator 130 may be able to determine which individuals are to obtain the alert notification. For example, the administrator 130 may be configured to select various groups of people (within the organization and/or outside of the organization) that should obtain the various alert notifications. In other embodiments, this determination may be made automatically by the system 100.

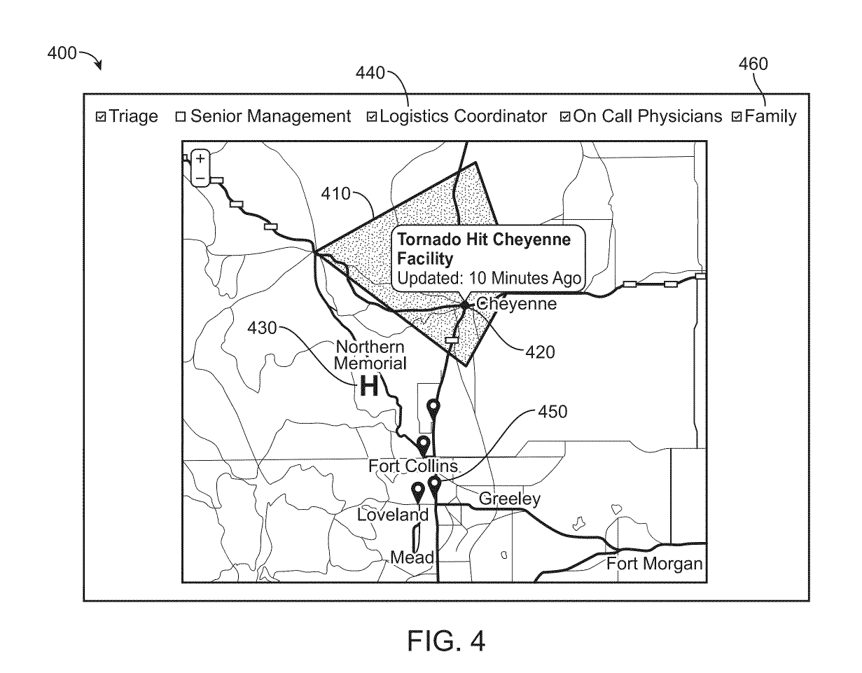

In some embodiments and as will be explained below, the notification module 190 may also be configured to output details about the alert notification in a user interface. For example, when an event occurs, the notification module may be configured to output information about the event on a map and provide the map to the various users of the system 100 such as shown in FIG. 4-FIG. 7B.

In some embodiments the notification module 190 may be used to send an alert notification or other message generated by a user such as, for example, User 1 110 or an administrator 130. For example, in some embodiments, the notification module 190 may obtain a message generated by a user. The notification module 190 may determine a list of possible message recipients based on, for example, organizational metadata associated with the message.

Regardless of how the message is generated, the notification module 190 is configured to determine list of recipients and communicate the alert notification and/or messages to and/or from the identified individuals. For example, a determination may be made that User 1 110 is in or near the area (e.g., within a threshold distance of the area) associated with the alert notification. In another example, User 1 110 may have identified an area of interest (e.g., User 1 110 has a family member, friend, friend of the family etc.) in the area associated with the alert notification. In still yet other embodiments, the message recipients may be identified based on a determined location (e.g., location information obtained from a mobile device or other computing device associated with the various individuals). In some additional embodiments, the various factors or criteria listed above may be combined.

Once the message and intended recipients are obtained and determined, notification module 190 may be used to transmit the messages to the intended recipients. The message may be transmitted and provided to the identified individuals through a push notification system, a Send Mail Transmission Protocol (SMTP), short message service (SMS), a multimedia messaging service (MMS) or other such communication medium.

Once the alert notifications are transmitted to the various users, the system 100 may be configured to obtain and track acknowledgement information. In some embodiments, the acknowledgement information may be an update from an individual that obtained the alert notification. For example, the alert notification may include a question as to the health, status, location and/or safety of the particular individual. In another embodiment, the system 100 may be configured to track whether various users have selected (e.g., read, tapped or opened an application) or otherwise acknowledged receipt of the alert notification. The acknowledgment information may then be provided to an administrator 130 or other user to help determine the severity of a particular emergency.

In other embodiments such as will be described below, the notification module 190 may also act as a message transport service that enables individuals to communicate with one another. For example, the administrator 130 may generate a survey or other message that asks first responders about available resources. The notification module 190 may be configured to obtain the response, aggregate the data, and provide the data to the administrator 130.

In another embodiment, the administrator 130 or other user may be able to check on locations (e.g., a last known location or a current location) of an individual who has not responded or otherwise acknowledged an alert notification or message associated with the alert notification. This information, as well as other information may be provided to the administrator (or other user) on a user interface.

The notification module 190 may also be used to send messages within the organization itself. For example, the notification module 190 may be utilized by various members in the organization (e.g., depending on or using group hierarchies) to send various messages. For example, the president of the organization may be able to utilize the notification module 190 to send a message to all employees while a group leader may only be able to send messages to other members of her group using the notification module 190.

The notification module 190 may also be used to provide individuals or other users with the ability to subscribe to various news feeds and/or alert notifications from other organizations. For example, a police station may have access to the feeds from various hospitals and fire stations in the area and vice versa.

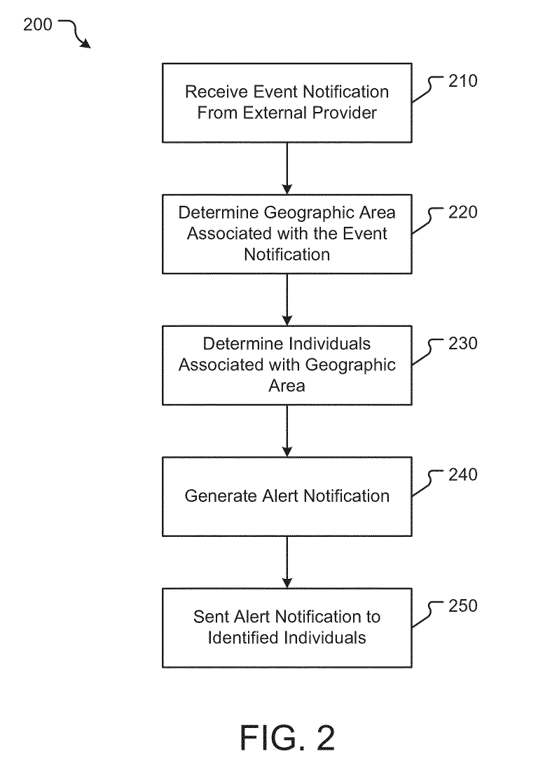

FIG. 2 illustrates a method 200 for generating alert notifications based on information obtained from various sources according to one or more embodiments of the present disclosure. In some embodiments, the method 200 may be used with a system that is configured to provide alert notifications to various individuals, such as, for example, system 100 described above with respect to FIG. 1.

Method 200 begins at operation 210 in which an event notification is obtained from an external source. In some embodiments, the event notification may be obtained from data scraping, social media, an RSS feed, various news organizations, the National Oceanic and Atmospheric Administration, the Federal Emergency Management Agency, the Federal Communications Commission, the Department of Homeland Security, the National Weather Service and so on.

As discussed above, the event notification may also be obtained from one or more users of the system, such as, for example, an administrator, a first responder, or other individual. In embodiments where the alert event is obtained from a user, the system, or an administrator of the system may enable or otherwise allow certain individuals to generate event notifications and/or alert notifications associated with obtained event notifications. For example, the system may have a hierarchy of permission levels in which a first individual or a first group of individuals may have a first permission level and a second individual or group of individuals has a second permission level. As such, the first group may provide event notifications and generate alert notifications while the second group may only provide event notifications.

Once the event notification is obtained, flow proceeds to operation 220 and a determination is made as to the geographic area associated with the event notification. In some embodiments, the geographic determination is made using information contained in the event notification. In other embodiments the user or entity submitting the event notification may specify an area associated with the event notification.

Flow then proceeds to operation 230 and a determination is made as to the individuals that are in, at, or near the geographic area associated with the event notification. Although geographic regions are specifically mentioned, it is contemplated that an individual may be flagged for notification about a particular event even if the individual is not in the area affected by the event notification. For example, a user or individual may specify a city, an address, a state or other such location as an area of interest. As such, when an event notification is determined to be associated with that particular location, the individual may be notified of the event based on the user specified interest in that particular area.

In other embodiments, operation 230 may be used to determine which members of a particular organization are within or near the area of interest. Further, a determination may be made as to which individuals in the organization are to obtain the generated alert notification. For example, a first group of people may have permissions and/or qualifications to obtain a first type of alert notification and a second group of people may have permissions or qualifications to obtain a second type of alert notification.

Flow then proceeds to operation 240 in which an alert notification is generated. In some embodiments, the alert notification may include a graphical user interface that specifies the area associated with the alert notification, individuals in, at or near the area associated with the event notification and so on.

Once the alert notification is generated, the alert notification may be sent 250 to the identified individuals. In some embodiments, the alert notification is provided to individuals based on certain criteria. For example, to obtain an alert notification, an individual may be identified as a first responder that is within a certain distance from the geographic area. In another embodiment, the criteria may be position within an organization (e.g., a doctor, a nurse, etc.).

In some embodiments, the alert notification may be a custom alert notification that is generated by an individual. This alert notification may be flagged for distribution to certain individuals or groups. For example, a first doctor may only want to receive notifications from another doctor or nurse in his organization or that is within a certain geographic area. In other embodiments, the alert notification may be flagged to be obtained by all individuals that have access to the system.

In some embodiments, each alert notification may include messaging capabilities such that one or more individuals that access the system may be able to track the location of individuals, the status of individuals, which individuals have acknowledged receipt of the alert notification and so on.

As discussed above, the alert notification may include an expiration period. That is, various alert notifications may be in effect for a set amount of time. Thus, if a first individual is outside an area of influence of the alert notification (e.g., 20 miles away from the area associated with the alert notification) but enters the area of influence (e.g., 10 miles away from the area of influence associated with the alert notification) before the alert notification expires, the individual may obtain the alert notification when they enter the affected area or come within a threshold distance. In some embodiments, the time period may be specified by an administrator, by the individual that created the alert notification and/or the feed from which the event notification was obtained. The expiration period, as well as the alert notification may be updated, reset, deleted, canceled or otherwise updated as more information is obtained.

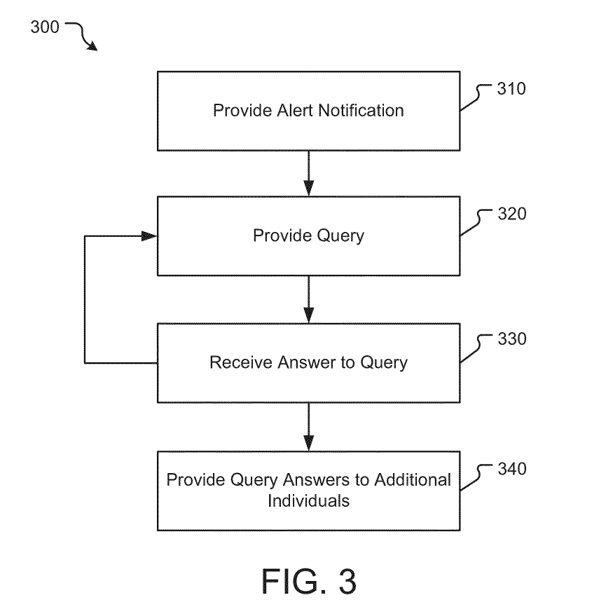

FIG. 3 illustrates a method 300 for providing additional information about an alert notification according to one or more embodiments of the present disclosure. In some embodiments, method 300 may be used by system 100 and/or in conjunction with method 200 described above.

Method 300 begins at operation 310 in which an alert notification is provided. In some embodiments, the alert notification may be generated by an individual who has been granted alert notification creation rights by an administrator or by the organization. The alert notification may include instructions to various recipients about where to go to obtain medical attention, areas affected by the emergency, location of first responders and so on. The alert notification may also be sent to people or individuals that are within certain circles and/or individuals that are in danger versus individuals that are not in danger.

In some embodiments, the alert notification may include a query 320 in which an administrator or other individual may use to obtain additional information about the emergency. For example, a query may include a question as to the location of an individual, whether the individual is hurt, and so on. In other embodiments, the query may include questions specifically for first responders. This may include status of a nearby hospital, what supplies are on hand, what emergency personnel are available, the location of the emergency personnel and so on.

Flow then proceeds to operation 330 in which answers to the query are obtained. In some embodiments, when an answer to a query is obtained, one or more follow-up questions or queries may be provided. For example, if an administrator or other individual obtains an answer to a query, the administrator may ask one or more additional questions to various individuals that acknowledged the query.

In some embodiments, the additional questions may be automatically generated and sorted or may be generated and sorted by human interaction. In other embodiments, the system may cause messages having a first type of response (e.g., responses that indicate injuries) to be provided to a particular individual while messages having a second type of response (e.g., responses that indicate the individual is not injured) to be obtained by a second individual or handled by the system.

From this information additional details may be provided to a user interface (e.g., a map other such interface) to give an administrator or other user, a better idea of the status of the emergency. As such, operation 340 provides that the additional information is provided to other individuals.

In some embodiments, the additional information may be asked for and obtained after the disaster or emergency has been addressed. Thus, users of the system can effectively audit how the emergency was handled and how they can improve. In addition, the system may be configured to store and track the various event conditions that were obtained, as well as the alert notifications that were generated. As such, in the event a similar emergency or a training event, the system may be configured to recognize the event and provide details as to what was successful in the previous event.

In some embodiments, the system described herein may be used to pass messages within the organization based on a hierarchy even if an emergency event has not occurred. For example, a group leader may send messages or identify a location on a map of a group meeting or activity and specify which individuals in the group or organization are to attend the meeting.

FIG. 4 illustrates an exemplary user interface 400 that may be used to show various alert notifications according to one or more embodiments of the present disclosure. For example, the user interface 400 illustrates an exemplary situational intelligence map that displays situational data about an event. As discussed above, the situational data may be collected and/or created by the system such as, for example, system 100.

As shown in FIG. 4, the user interface 400 may include a first alert notification 410 that was generated based on an event notification obtained from an external alert source (e.g., a government entity). In this example, the event notification may be a tornado warning. Continuing with the example, the event notification may include a geographic area affected or potentially affected by the event notification, a time period associated with the event notification and/or a group of users or individuals that should be notified about the event notification.

As also shown, the user interface 400 may also include a second alert notification 420. In the exemplary embodiment, the second alert notification 420 is generated by an individual, an organization and/or its constituents. As discussed, the custom alert notification may be generated based on a hierarchy within the organization providing the alert notification or other such individual. As shown, the alert notification may include a custom message (e.g., “Tornado Hit Cheyenne Facility”) as well as when the second alert notification 420 was last updated. As also shown, the user interface 420 may provide a geographic area affected by the second alert notification 420.

The user interface 400 may also provide information about a location designated by an organization or its constituents. For example, the user interface 400 may show the location of the nearest hospital 430. In some embodiments, this information may be provided using a GPS, longitude and latitude coordinates, a street address, a name of the facility and so on.

In some embodiments, the user interface may include various check box selectors that are configured to filter which individuals, groups, organizations or members should be displayed on the user interface 400. In one implementation, the user interface may be configured to display a work circle 440 in which the user interface 400 would display individual members, as well as their last known or current location. Further, clicking on an indicator (e.g., indicator 450) may provide additional information about the individual including their picture, the last message sent, survey response obtained and so on. Likewise, selection of the family circle 460 may provide similar information about family members, close friends, friends of friends and so on.

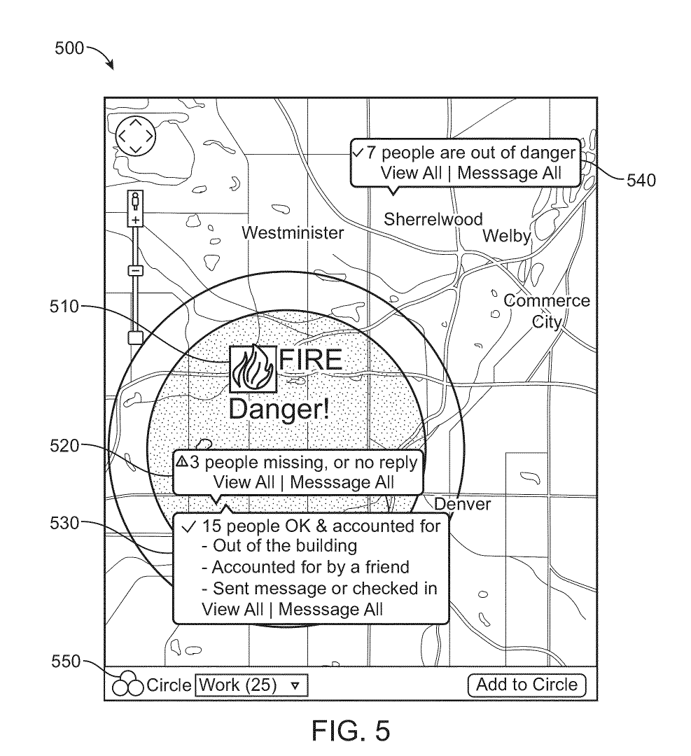

FIG. 5 illustrates an exemplary user interface 500 that may be used by an administrator or other user to provide information about various individuals associated with an alert notification 510 according to one or more embodiments of the present disclosure. As shown in FIG. 5, the user interface 500 may include an alert notification 510. As discussed above, the alert notification 510 may be generated by an individual or may be obtained from an external alert service.

The user interface may also include a status update of various individuals that are associated with the alert notification 510. For example, as shown, the user interface 500 includes a notification 520 that three people are missing or have not replied or otherwise acknowledged a message sent by the system. In such events, the user interface 500 may enable an individual or administrator to view who has not responded, send a message to the identified individuals, view their last known location and so on.

The user interface 500 may also present a notification 530 of various individuals who have been accounted for. For example, the notification 530 may identify that various individuals are out of the building, have been accounted for by a friend, have sent a message or have otherwise updated their status. In some embodiments, the user interface 500 may enable an individual or administrator to view who has responded, send a message to the identified individuals, view their last known location and so on.

The user interface 500 may also present information regarding individuals that are not within a threshold distance of the area associated with the alert notification 510. This is shown by notification 540. As shown, notification 540 may indicate that seven people are out of danger and enables a user or other individual to view these individuals, send messages to the individuals and so on.

The user interface 500 may also include a selection mechanism 550 that enables a user to toggle between different views and individuals in various circles. For example, a first circle may be co-workers while a second circle may be family members and friends. Although specific circles are mentioned, it is contemplated that other circles may be used and generated. For example, a circle may be created for second level connections (e.g., friends of friends) and so on. When such circles are selected, the user interface 500 may show impact areas near or at the last known location of these individuals.

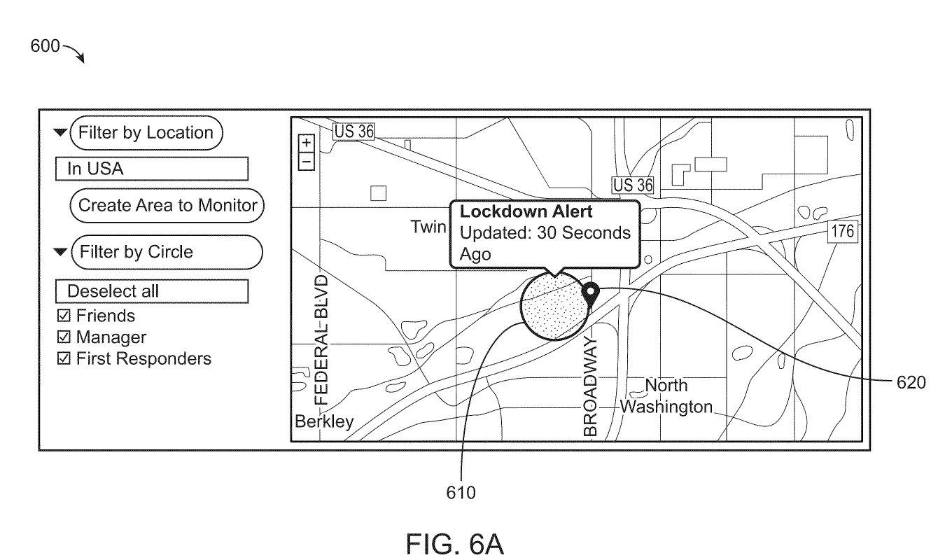

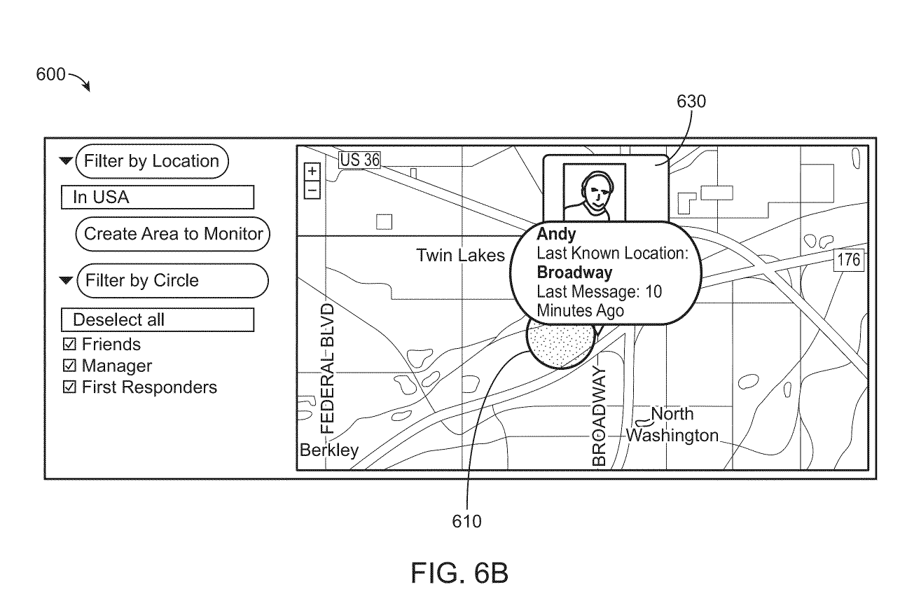

FIG. 6A-FIG. 6B illustrate additional exemplary user interfaces 600 that may be used to provide information about an alert notification according to one or more embodiments of the present disclosure. As shown in these figures, the user interface 600 may include a user generated alert notification 610 as well as information about the alert notification. In addition, the marker 620 indicates an individual that may be associated with the alert notification 610. In some embodiments, clicking on or otherwise selecting the marker 620 shows additional information about the individual including the individual's name, their last known location, the last message they sent, the time their last message was obtained and so on.

The user interface 600 may also enable an individual to filter data based on location and/or based on a defined group of people. For example, the filters that are selected may include friends, first responders and managers. As each filter is selected, these various individuals, or their last known location and/or safety status, may be output on the user interface 600. In other embodiments, the user interface may enable an individual to create a custom area to monitor.

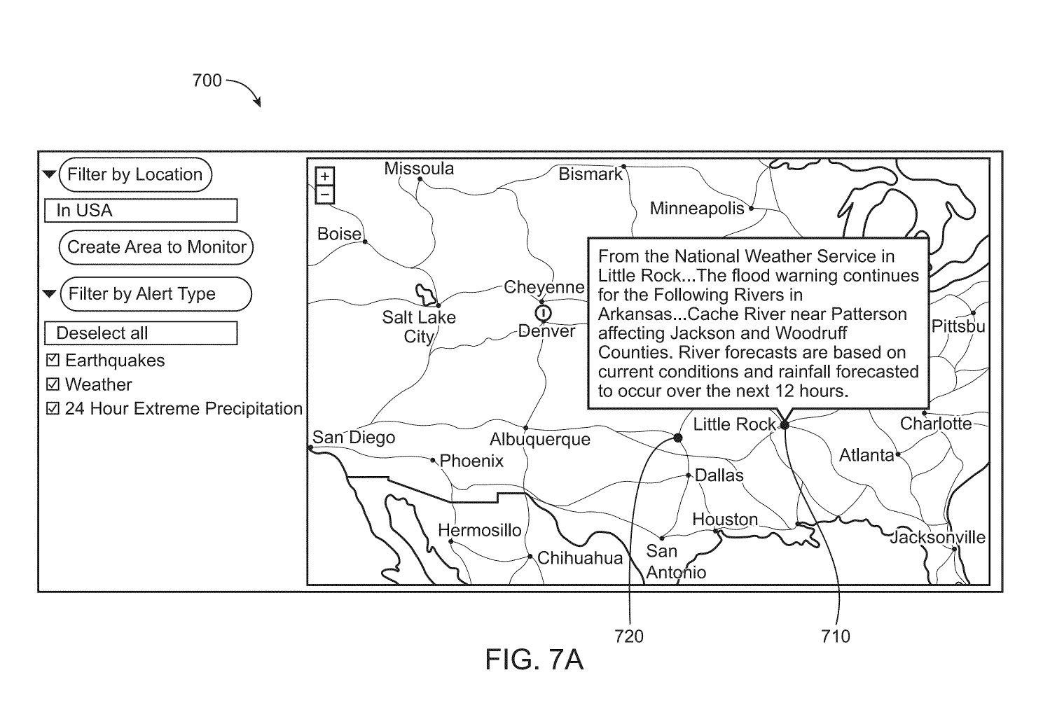

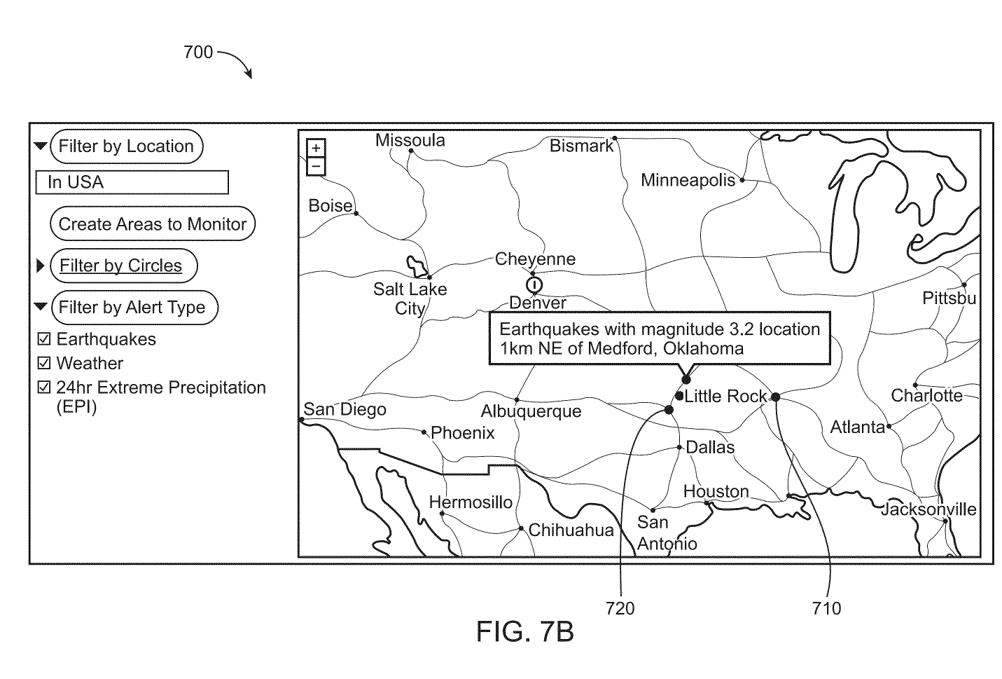

FIG. 7A-FIG. 7B illustrate another exemplary user interface 700 that may be used to provide information about one or more alert events according to one or more embodiments of the present disclosure. As shown in these figures, the user interface 700 may present a nationwide map (or other selectable area) and shown different types of alerts from various external alert sources. For example, alert notifications 710 may be from a first service (e.g., the United States Geological Survey (USGS)) while the second alert notification 720 may be provided by a second service (e.g., the National Weather Service). As shown, selecting each alert notification may provide additional details about each alert.

Although various exemplary user interfaces are shown, embodiments of the present disclosure are not so limited. In some embodiments, the user interface may parse various information feeds and provide them on various user interfaces. For example, in the case of an earthquake, the system may parse USGS shake maps for approximate ground-motion alerts beyond the epicenter of a seismic event. In other embodiments, the system could parse fire maps, hurricane maps and so on for activity as well as identifying hot and cold spots. Further, the information in each user interface may be combined.

In still yet other embodiments, a user or an administrator of the system could define various resolutions at which to view the incoming and/or outgoing data associated with an event notification or an alert notification. For example, an administrator or other individual might want near-constant updates on first responders, as well as on end users who haven't positively checked in during an emergency. In other scenarios, an administrator might want near-constant updates on individuals as they are away from safe areas. In some embodiments, an end user or administrator may choose to modify the resolution of the data on an endpoint which may be used to conserve system resources (server cycles and database hits, for example) as well as to conserve energy used by the system on an endpoint.

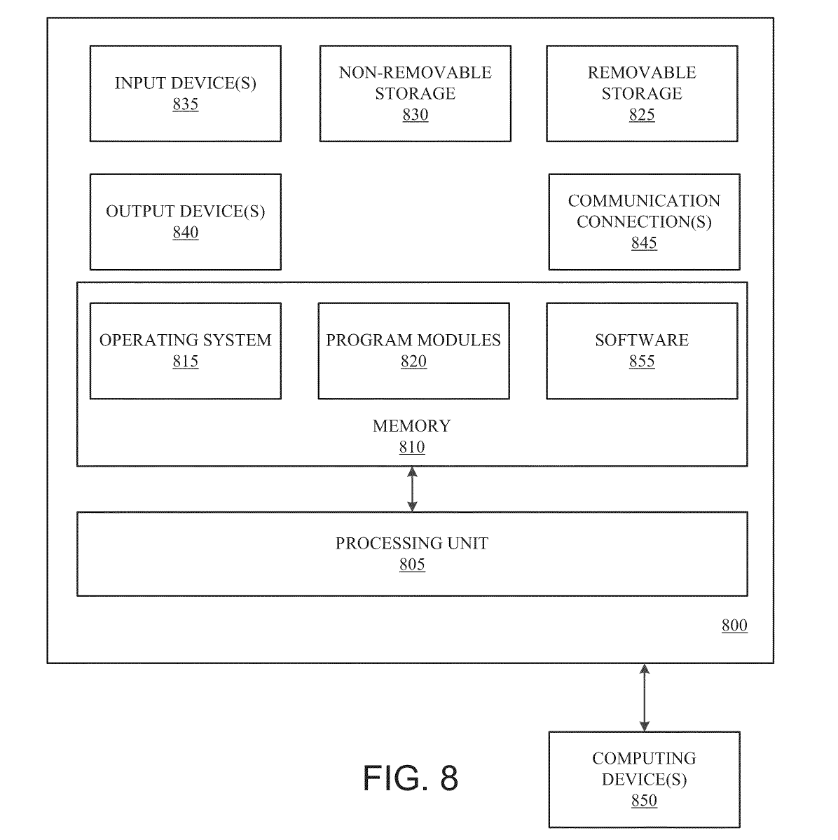

FIG. 8 is a block diagram illustrating physical components (i.e., hardware) of a computing device 800 according to embodiments of the present disclosure. The computing device 800 and its various components are suitable for the computing devices described above including the server computing device 160 and the various other computing devices used by the various users and individuals of the system 100.

In a basic configuration, the computing device 800 may include at least one processing unit 805 and a system memory 810. Depending on the configuration and type of computing device, the system memory 810 may comprise, but is not limited to, volatile storage (e.g., random access memory), non-volatile storage (e.g., read-only memory), flash memory, or any combination of such memories. The system memory 810 may include an operating system 815 and one or more program modules 820 suitable for running software applications 855. The operating system 815 may be suitable for controlling the operation of the computing device 800 and may be capable of providing the various user interfaces described herein.

Furthermore, embodiments of the present disclosure may be practiced in conjunction with a graphics library, other operating systems, or any other application program and is not limited to any particular application or system. The computing device 800 may have additional features or functionality. For example, the computing device 800 may also include additional data storage devices (removable 825 and/or non-removable 830 storage devices) such as, for example, magnetic disks, optical disks, or tape.

Various program modules and data files may be stored in the system memory 810. While executing on the processing unit 805, the program modules 820 may perform processes including, but not limited to, one or more of the stages of the methods 200 and 300 illustrated in FIG. 2-FIG. 3.

Furthermore, embodiments of the present disclosure may be practiced in an electrical circuit comprising discrete electronic elements, packaged or integrated electronic chips containing logic gates, a circuit utilizing a microprocessor, or on a single chip containing electronic elements or microprocessors. For example, one or more embodiments may be practiced via a system-on-a-chip (SOC) where each or many of the components illustrated in FIG. 8 may be integrated onto a single integrated circuit. Such a SOC device may include one or more processing units, graphics units, communications units, system virtualization units and various application functionality all of which are integrated onto or otherwise associated with the chip substrate as a single integrated circuit. When operating via a SOC, the functionality, described herein may be operated via application-specific logic integrated with other components of the computing device 800 on the single integrated circuit.

Embodiments of the present disclosure may also be practiced using other technologies capable of performing logical operations such as, for example, AND, OR, and NOT, including but not limited to mechanical, optical, fluidic, and quantum technologies. In addition, embodiments of the present disclosure may be practiced within a general purpose computer or in any other circuits or systems.

The computing device 800 may also have one or more input device(s) 835 such as a keyboard, a mouse, a pen, a sound input device, a touch input device, etc. The output device(s) 840 such as a display, speakers, a printer, etc. may also be included and provide the user interfaces described herein.

The computing device 800 may include one or more communication connections 845 allowing communications with other computing devices 850. Examples of suitable communication connections 845 include, but are not limited to, RF transmitter, obtainer, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules. The system memory 810, the removable storage device 825, and the non-removable storage device 830 are all computer storage media examples (e.g., memory storage).

Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800.

Communication media may be embodied by computer-readable instructions, data structures, program modules, or other data in a modulated data signal, such as a carrier wave or other transport mechanism, and includes any information delivery media. By way of example, and not limitation, communication media may include wired media such as a wired network or direct-wired connection, and wireless media such as acoustic, radio frequency (RF), infrared, and other wireless media.

Embodiments of the present disclosure are described above with reference to block diagrams and operational illustrations of methods and the like. The operations described may occur out of the order as shown in any of the figures. Additionally, one or more operations may be removed or executed substantially concurrently. For example, two blocks shown in succession may be executed substantially concurrently. Additionally, the blocks may be executed in the reverse order.

The description and illustration of one or more embodiments provided in this disclosure are not intended to limit or restrict the scope of the present disclosure as claimed. The embodiments, examples, and details provided in this disclosure are considered sufficient to convey possession and enable others to make and use the best mode of the claimed embodiments. Additionally, the claimed embodiments should not be construed as being limited to any embodiment, example, or detail provided above. Regardless of whether shown and described in combination or separately, the various features, including structural features and methodological features, are intended to be selectively included or omitted to produce an embodiment with a particular set of features. Having been provided with the description and illustration of the present application, one skilled in the art may envision variations, modifications, and alternate embodiments falling within the spirit of the broader aspects of the embodiments described herein that do not depart from the broader scope of the claimed embodiments.

We claim:

1. A method for providing alert notifications, the method comprising:
obtaining an event notification from an external source;
determining a geographic area associated with the event notification;
determining one or more users in the geographic area that meet one or more alert criteria;
generating an alert notification based, at least in part, on the event notification; and
providing the alert notification to one or more users in geographic area that meet the one or more alert criteria.

2. The method of claim 1, further comprising obtaining a response from at least one user of the one or more users in the geographic area.

3. The method of claim 2, wherein the response is associated with a condition of an organization or device that provided the alert notification.

4. The method of claim 2, further comprising tracking the response from the at least one user of the one or more users in the geographic area.

5. The method of claim 1, further comprising sending the alert notification to a second user of the one or more users when it is determined that the second user has entered the geographic area and has not obtained the alert notification.

6. The method of claim 1, wherein the alert notification has an expiration period.

7. The method of claim 1, wherein the alert notification is obtained from an individual.

8. The method of claim 1, wherein the alert notification is obtained from an organization.

9. The method of claim 1, further comprising displaying the geographic area on a map.

10. The method of claim 1, further comprising providing the location of one or more users that meet the alert criteria on a map.

11. A computer-readable storage medium encoding computer executable instructions which, when executed by a processor, performs a method for providing alert notifications, the method comprising:
obtaining an event notification from an external source;
determining a geographic area associated with the event notification;
determining one or more users in the geographic area that meet one or more alert criteria;
generating an alert notification based, at least in part, on the event notification; and
providing the alert notification to one or more users in geographic area that meet the one or more alert criteria.

12. The computer-readable storage medium of claim 11, further comprising instructions for obtaining a response from at least one user of the one or more users in the geographic area.

13. The computer-readable storage medium of claim 12, wherein the response is associated with a condition of an organization that provided the alert notification.

14. The computer-readable storage medium of claim 12, further comprising instructions for tracking the response from the at least one user of the one or more users in the geographic area.

15. The computer-readable storage medium of claim 11, further comprising instructions for sending the alert notification to a second user of the one or more users when it is determined that the second user has entered the geographic area and has not obtained the alert notification.

16. The computer-readable storage medium of claim 11, wherein the alert notification has an expiration period.

17. A system comprising:
a processor; and
a memory coupled to the processor, the memory for storing instructions which, when executed by the processor, causes the processor to perform a method for providing alert notifications, the method comprising:
obtaining an event notification from an external source;
determining a geographic area associated with the event notification;
determining one or more users in the geographic area that meet one or more alert criteria;
generating an alert notification based, at least in part, on the event notification; and
providing the alert notification to one or more users in geographic area that meet the one or more alert criteria.

18. The system of claim 17, further comprising instructions for sending the alert notification to a second user of the one or more users when it is determined that the second user has entered the geographic area and has not obtained the alert notification.

19. The system of claim 17, wherein the alert notification is obtained from an individual.

20. The system of claim 17, wherein the alert notification is obtained from an organization.
